(19) United States
(12) Patent Application Publication
(10) Pub. No.: US 2006/0021179 A1
(43) Pub. Date: Feb. 2, 2006

(54) Universal adapter for a windshield wiper

(76) Inventors: Chih-Ming Yang, Taipei City (TW); Chuan-Chih Chang, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/033,632

(22) Filed: Jan. 13, 2005

(30) Foreign Application Priority Data
Jul. 27, 2004 (TW) 93211892

(51) Int. Cl. B60S 1/40

(52) U.S. Cl. 15/250.32; 15/250.351

(57) ABSTRACT

This invention relates to a universal adapter for a windshield wiper and is used to interface a windshield wiper with a driving wiper arm. The adapter has a body and a base, and the body is a casing having a jumper connection unit and a jack, in which the jumper connection unit of the body is concave on a top surface of the body and extends to a front side of the body. The jack is a hole formed vertically inward into a rear side of the body, and the jumper connection unit and the jack are provided to connect with the driving wiper arm. The base extends to the inside of the body, a hook is provided under the base, and the hook is wedged onto the wiper.

### BACKGROUND OF THE INVENTION

1. Field of the Invention

This invention relates to a universal adapter for a windshield wiper and particularly to an adapter serving as an interface for the wiper and a driving wiper arm.

2. Description of Related Art

Conventionally, the windshield wiper is used to wipe rain or dirt adhering to a windshield of a car and thereby to maintain line of sight for a driver in the interest of safety, in which the wiper is driven by the driving wiper arm.

A general wiper is structured with a framework and a bar fixed onto the framework provided with a connection portion to connect with the driving wiper arm. The driving arm is thereby connected to the wiper to drive the wiper to wipe. The conventional driving wiper arms mentioned above provide for various models, such as an insertion type, a hook type, a pivot-joint type, according to various vehicle manufacturers. Thus, the wiper and the driving arm must co-operate through the adapter so that the wiper may be used for various models of driving arm. For this reason, the existing wiper may be sold attached with an adapting element so as to match with various models of driving arms, a universal windshield wiper thereby being formed.

However, the above-mentioned universal wiper structure cannot be used with wiper arms of some imported sedans, and if the universal wiper attached with the adapting element is used on the imported sedans,.another model of adapter for the arms of imported sedans must be designed to connect with the conventional universal wiper.

### SUMMARY OF THE INVENTION

This invention mainly provides a universal adapter for a windshield wiper, providing a mutual connection between a universal wiper and a driving wiper arm of an imported sedan.

In order to achieve the object mentioned above, this invention provides the universal adapter as an interface between the windshield wiper and a driving wiper arm. The adapter comprises a body provided with a jumper connection unit and a jack that are both connected to the driving wiper arm. A base is located under the body and provided with a hook wedged onto the wiper.

To provide a further understanding of the invention, the following detailed description illustrates embodiments and examples of the invention. Examples of the more important features of the invention thus have been summarized rather broadly in order that the detailed description thereof that follows may be better understood, and in order that the contributions to the art may be appreciated. There are, of course, additional features of the invention that will be described hereinafter which will form the subject of the claims appended hereto.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a front side view of a preferred embodiment of this invention;

FIG. 2 is a rear side view of the preferred embodiment of this invention;

FIG. 3 is a top view of the preferred embodiment of this invention;

FIG. 4 is an exploded view of the preferred embodiment of this invention in use; and

FIG. 5 is an assembly view of the preferred embodiment of this invention in use.

### DETAILED DESCRIPTION OF THE PREFERRED EMBODIMENTS

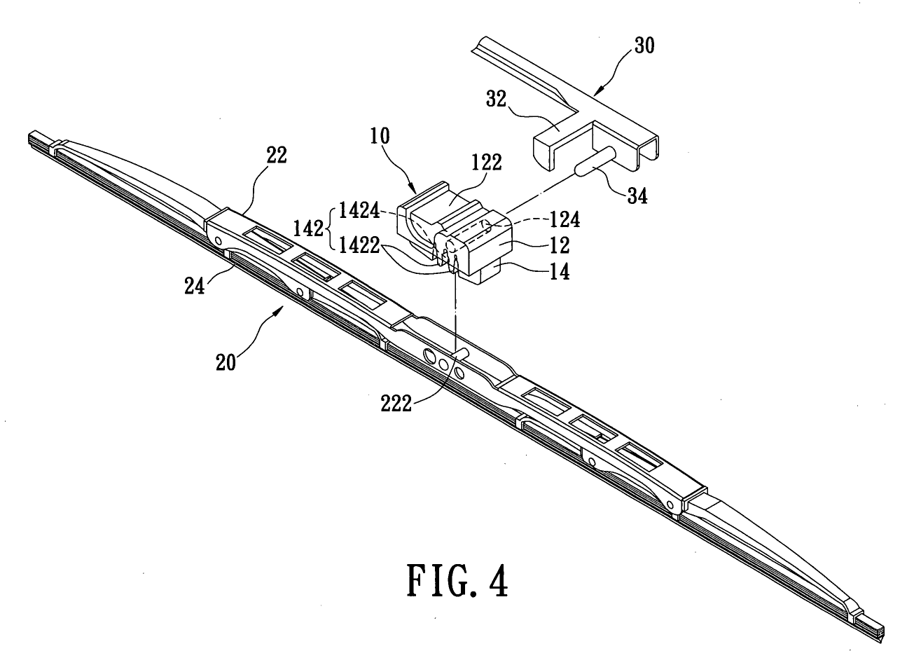

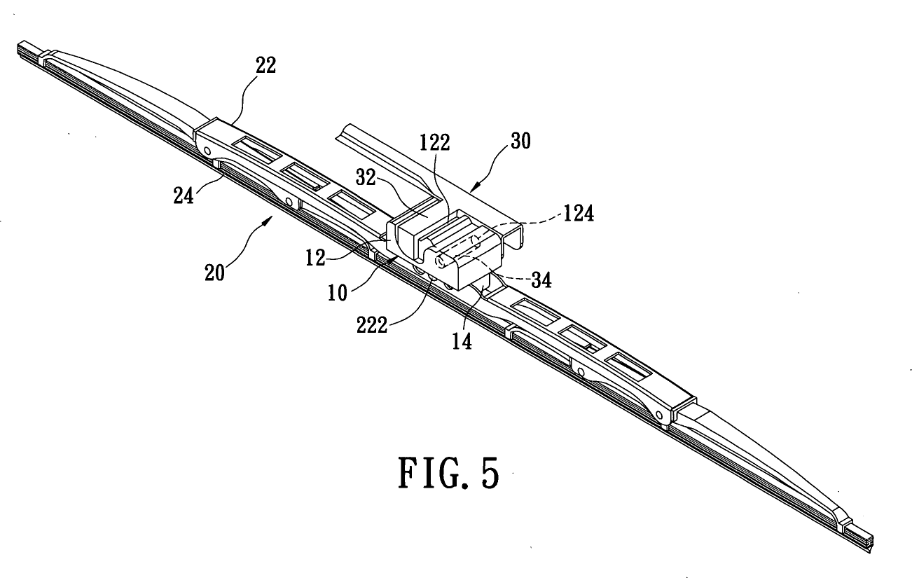

FIGS. 4 and 5 are an exploded view and an assembly view of a preferred embodiment of this invention in use, respectively. This invention provides a universal adapter 10 for a windshield wiper, which is used to connect a windshield wiper 20 to a driving windshield wiper 30. The adapter 10 comprises a body 12 and a base 14.

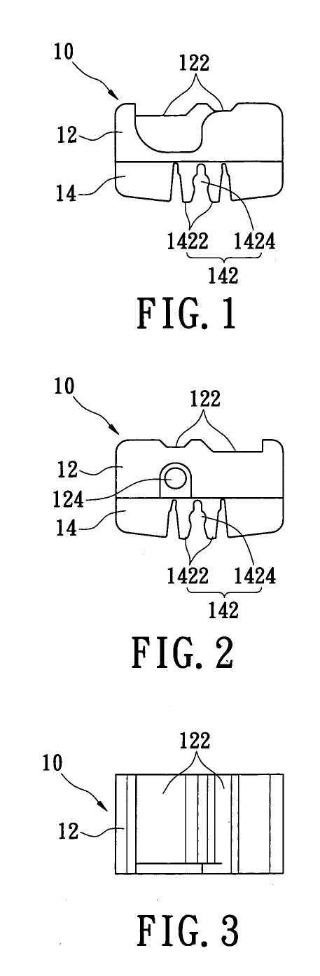

The body 12 is a rectangular casing and has a jumper connection unit 122 and a jack 124. The jumper connection unit 122 of the body 12 is concave on a top surface of the body 12 and extends to a front side of the body 12. The jumper connection unit 122 is located on the top surface of the body 12 to form two capacity grooves that are horizontal and adjacent to each other (as shown in FIG. 3). The grooves are separately vertical and extend to the front side of the body, which forms a rabbet inward concavity (as shown in FIG. 1). The rabbet and the grooves are provided to form the jumper connection unit 122 and the jack 124 is a hole formed vertically inward into a rear side of the body 12 (as shown in FIG. 2). A front end of the arm 30 is transversally vertical to form a jumper connection arm 32 and an insertion pole 34. The jumper connection 122 is provided for the jumper connection arm of the driving wiper arm 30 to match transversally. The jack 124 is provided for insertion therein of the insertion pole 34 of the driving wiper arm 30. Through the jumper connection unit 122 and the jack 124, the driving wiper arm 30 is joined to the body 12 of adapter 10.

The base 14 is a mostly rectangular casing and vertically extends to the inside of the body 12. A hook 142 is provided under the base 14 and provided with a plurality of grooves upward vertically concave from a bottom of the base 14 until each groove is formed into clamping legs 1422 opposite each other. The windshield wiper 20 is structured with a framework 22 and a bar 24 fixed onto the framework 22 on which a connection portion 222 is provided serving as a pole. A clipping groove 1424 between the clamping legs is provided for the connection portion 222 of the wiper 20 to be clamped therein, and thereby the base 14 is wedged onto the wiper 20 through the hook.

Thus, the characteristics of this invention are shown as follows. The body 12 according to this invention has the jumper connection unit 122 and the jack 124, the front end of the arm 30 is transversally vertical to form the jumper connection arm 32 and the insertion pole 34, the jumper connection 122 of the body 12 is provided for the jumper connection arm 32 of the driving wiper arm 30 to transversally match, and the jack 124 is provided for the insertion pole 34 of the driving wiper arm 30 to be inserted therein. The base 14 vertically extends to the inside of the body 12, the hook 142 is provided under the base 14, the base 14 is wedged onto the wiper 20 through the hook 142, and this invention connects the windshield wiper 20 with the driving windshield wiper 30 through the body 12 and the base 14 so that a driving wiper arm installed on a high-class sedan in the minority may be adapted to a conventional universal windshield wiper.

However, in the description mentioned above, only the preferred embodiments according to this invention are provided without limit to claims of this invention; all those skilled in the art without exception should include the equivalent changes and modifications as falling within the true scope and spirit of the present invention.

What is claimed is:

1. A universal adapter for a windshield wiper, used as an interface between a windshield wiper and a driving wiper arm, comprising:
a body provided with a jumper connection unit and a jack, wherein the jumper connection unit and the jack are both connected to the driving wiper arm; and
a base extending to the body and having a hook wedged onto the wiper.

2. The universal adapter for a windshield wiper according to claim 1, wherein the jumper connection unit is concave on a top surface of the body and extends to a side of the body.

3. The universal adapter for a windshield wiper according to claim 1, wherein the jack is a hole formed vertically inward into another side of the body.

4. The universal adapter for a windshield wiper according to claim 1, wherein the hook is located under the base.
